(19) United States
(12) Patent Application Publication
(10) Pub. No.: US 2016/0188844 A1
(43) Pub. Date: Jun. 30, 2016

(54) CLOUD BASED EMR MANAGER

(71) Applicant: CERNER INNOVATION, INC., Kansas City, KS (US)

(72) Inventors: DOUGLAS W. WAGER, KANSAS CITY, MO (US); SARA JANE GRIFFIN, LEE'S SUMMIT, MO (US); RYAN M. MOOG, OLATHE, KS (US); MARSHA LAIRD-MADDOX, KANSAS CITY, MO (US)

(21) Appl. No.: 14/587,244

(22) Filed: Dec. 31, 2014

(51) Int. Cl. G06F 19/00

(52) U.S. Cl. CPC G06F 19/363; G06F 19/322

(57) ABSTRACT

Methods are directed at utilizing a patient's electronic medical record (EMR) information accessed from a cloud, such as that used in Blue Button technology. Once the patient's EMR information is downloaded from the cloud, it is used to automatically determine if the patient is eligible to participate in a clinical trial. The EMR information of the patient is also utilized to determine if there is a potential drug-drug interaction from of the one or more medications the patient is prescribed to take. Furthermore, the patient's EMR information is used to identify any warnings and indications regarding the one or more medications the patient is prescribed to take. Notifications are then sent to a patient device and devices of those that have permission from the patient to receive such information, such as family members.

### BACKGROUND

Blue Button technology was first utilized by the U.S. Department of Veterans Affairs (VA) in 2010. Blue Button refers to a logo in which patients can click the logo on a website and download their electronic medical record (EMR) in digital form. Since the successful utilization of Blue Button by the VA, several medical data holders have introduced Blue Button technology to their patients. Such medical data holders include the Centers for Medicare & Medicaid Services, Health and Human Services and the Department of Defense as well as private health plans such as United HealthCare, Aetna and others.

A patient's EMR data can be stored in a cloud. Cloud storage is a model of networked enterprise storage where data is stored in virtualized pools of storage which are generally hosted by third parties. A patient's EMR data in the cloud can be downloaded by an application. An application is all the computer software that causes a computer to perform useful tasks beyond the running of the computer itself. Applications have been developed to aid in the Blue Button technology. For example, the VA214 Blue Button application developed by Northrop Grumman allows veterans to remotely access their EMR data from a smartphone. Another example is Humetrix, Inc., which offers a mobile Blue Button application through which patients can send their EMR data directly to their medical provider. A patient's EMR data can be downloaded from one or more medical entities and stored in a cloud via an application. Medical entities comprise hospitals, urgent care facilities, pediatrician offices, and the like.

While downloading a patient's EMR via Blue Button technology is becoming commonplace, there is a lack of many examples of applications that then do something with the downloaded EMR information. Embodiments of the present invention describe methods of utilizing the downloaded EMR information of a patient.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter. The present invention is defined by the claims.

Embodiments of the present invention provide methods for utilizing an application to download EMR information for a patient from one or more medical entities and storing the EMR information in a cloud. In one embodiment, the EMR information in the cloud is accessed to determine if the patient qualifies for a clinical trial. In another embodiment, the EMR information in the cloud is accessed to identify any potential drug-drug interactions from the medications the patient is currently taking. In yet another embodiment, the EMR information in the cloud is accessed to identify any warnings and indications of the medications the patient is currently taking. Next, the patient is notified of the results through a patient device. In addition, people to which the patient has given permission to receive the results are notified through one or more devices that belong to the people.

In one embodiment, there is a method in a medical information computing environment for notifying a patient of clinical trial eligibility, the method comprising: utilizing an application for the following: downloading EMR information for a patient from one or more medical entities; storing the downloaded EMR information for the patient in a cloud; accessing the EMR information for the patient in the cloud in accordance with patient permissions and preferences; determining if there are one or more clinical trials near the patient; if there are the one or more clinical trials near the patient, automatically comparing the patient's EMR information to the one or more clinical trial participation qualifications; determining if the patient is eligible to participate in the one or more clinical trials; notifying a patient device of results; and notifying the results to one or more devices that belong to people that the patient has given permission to receive the results.

In another embodiment, there is a method in a medical information computing environment for notifying a patient of drug-drug interactions, the method comprising: utilizing an application for the following: downloading EMR information for a patient from one or more medical entities; storing the downloaded EMR information for the patient in a cloud; accessing the EMR information for the patient in the cloud; listing one or more medications the patient is currently taking; listing a dosage and administration information of the one or more medications the patient is currently taking; identifying one or more possible drug-drug interactions based on a list of two or more medications the patient is currently taking; if there is the one or more drug-drug interactions, notifying a patient device of results; and notifying the results to one or more devices that belong to people that the patient has given permission to receive the results.

In a further embodiment, there is a method in a medical information computing environment for identifying any warnings or indications regarding the one or more medications the patient is currently taking, the method comprising: utilizing an application for the following: downloading EMR information for a patient from one or more medical entities; storing the downloaded EMR information for the patient in a cloud; accessing the EMR information for the patient in the cloud; listing one or more medications the patient is currently taking; identifying any warnings and indications regarding the one or more medications the patient is currently taking; notifying a patient device of results; and notifying the results to one or more devices that belong to people that the patient has given permission to receive the results.

### BRIEF DESCRIPTION OF THE SEVERAL VIEWS OF THE DRAWINGS

FIG. 1 is a schematic diagram of a suitable computing system environment for use in implementing the present invention;

FIG. 2 is a flow diagram illustrating one method for delivering EMR information to a mobile device of the patient as well as the mobile devices of family members;

FIG. 3 is a flow diagram illustrating a method of automatically determining if a patient is eligible to participate in a clinical trial;

FIG. 4 is a flow diagram illustrating a method of identifying possible drug-drug interactions of the medications the patient is prescribed to take; and

FIG. 5 is a flow diagram illustrating a method of identifying warnings and indications of the medications the patient is prescribed to take.

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

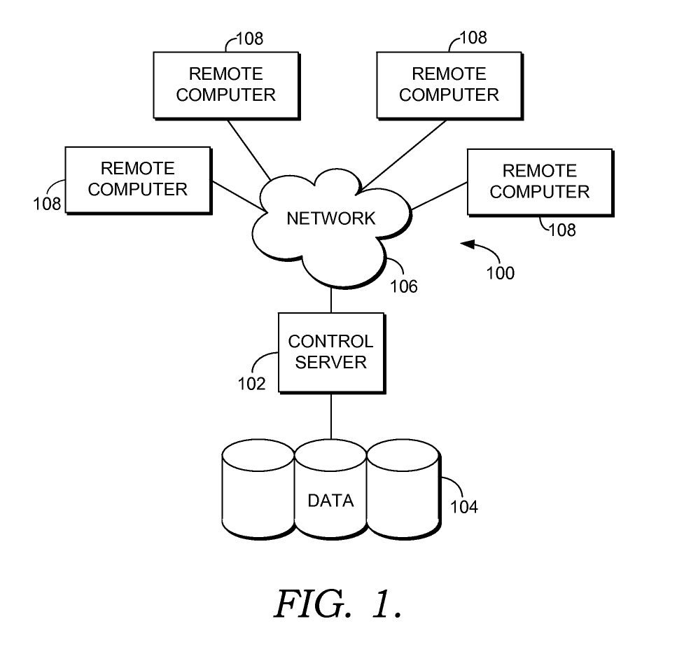

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of non-transitory computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

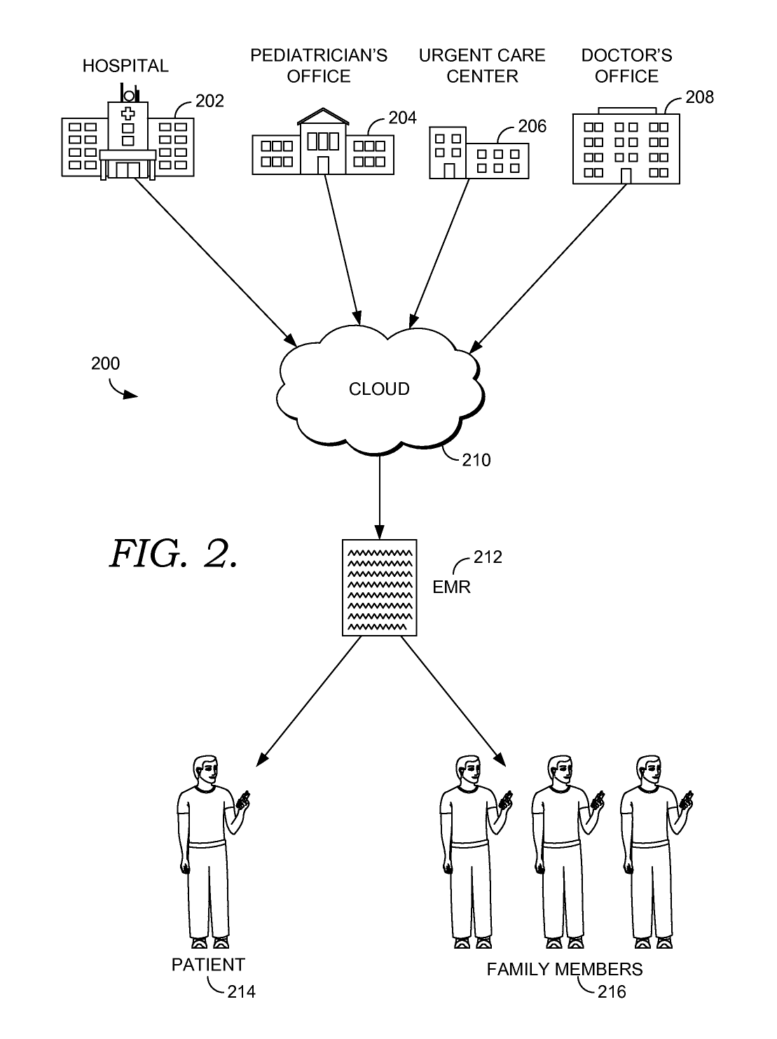

Turning now to FIG. 2, illustrated is the delivery of the patient's EMR information to a mobile device of a patient as well as the mobile devices of family members that have permission to receive the patient's EMR information 200. In one embodiment, those that have permission to receive the patient's EMR information can be family members 216, friends, acquaintances, guardians and the like. Next, an application downloads the patient's EMR information from medical entities that the patient has visited, such as a hospital 202, pediatrician's office 204, urgent care center 206, doctor's office 208, and the like. The downloaded EMR information is then stored in a cloud 210. The cloud can be a public or personal cloud. The EMR information is then accessed wherein the EMR information is combined into a single EMR 212 or the EMR information is maintained as separate EMRs (not shown). In one embodiment, the EMR information of the patient is all available EMR information, while in another embodiment, the patient's EMR information is a subset of all the EMR information. Once accessed from the cloud, the patient's EMR information can be downloaded to the patient's mobile device 214, such as a smartphone, PDA, Blackberry, and the like. The EMR information can be in the form of a text message or email. In another embodiment, the EMR information can be available on a secure website on a computer to which the patient has access and those that have permission from the patient have access.

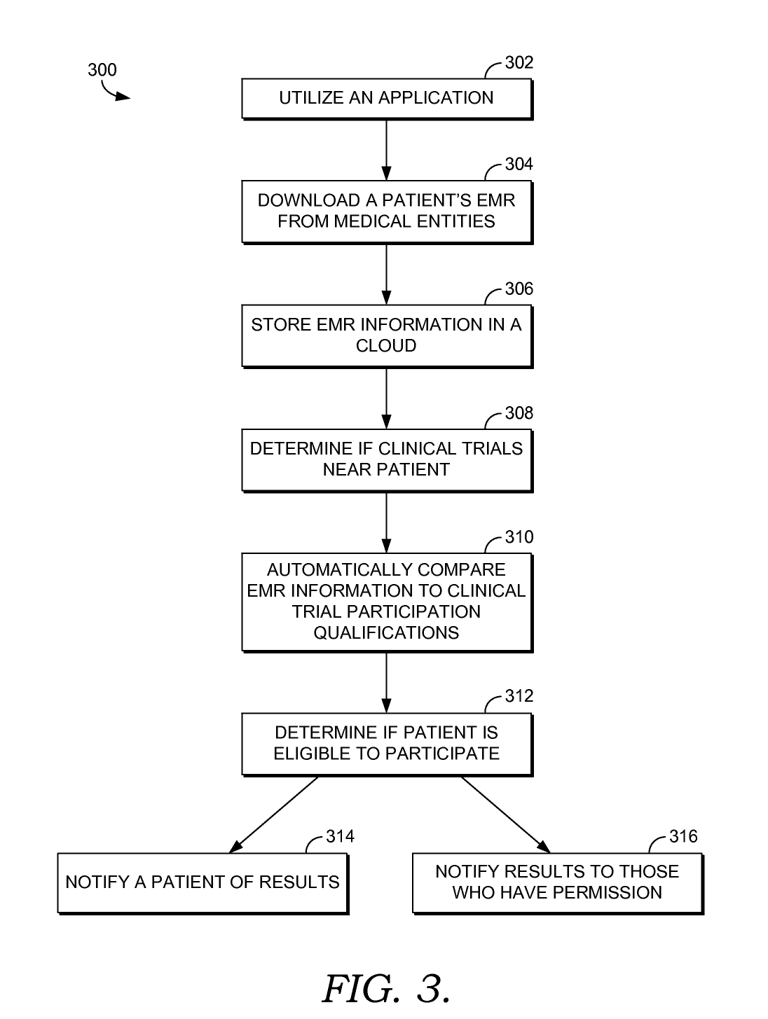

Turning to FIG. 3, notifying a patient and/or those that have permission from the patient of any clinical trials in which the patient is eligible to participate is illustrated as a block diagram 300. At step 302, an application is utilized to download a patient's EMR information from medical entities 304. At step 306, the patient's EMR information is stored in a cloud. Next, the EMR information for the patient that is stored in the cloud is accessed (not shown). At step 308, it is determined if there are any clinical trials near the patient. Whether clinical trials are “near” a patient is determined by the patient and/or those that have permission from the patient. For example, the patient might decide that a clinical trial is “near” him or her if the clinical trial is within 50 miles of their residence. In another embodiment, if the patient is elderly, for example, then clinical trials considered “near” the patient can be determined by those that have permission from the patient, such as family members. In this case, the family members might decide that “near” is closer to the patient's residence, such as within 15 miles of their residence. At step 310, the patient's EMR information is automatically compared to the clinical trial participation qualifications. In one embodiment, participation qualifications of a clinical trial are unique to each clinical trial. For example, in one clinical trial, the medical entity holding the clinical trial may be looking for people that are light to non-smokers and taking no medications. In a different example, the medical entity holding the clinical trial may be looking for people that are non-smokers, depressed, or on anti-depressant medication.

In one embodiment, EMR(s) from one or more patients of the one or more healthcare providers is accessed utilizing a cloud-based application. Next, clinical trial eligibility requirements of the one or more clinical trials from the one or more clinical trial sponsors are uploaded utilizing a cloud-based application (not shown). One or more patients are matched to the one or more clinical trials in which they are eligible to participate, based on the EMR information and the clinical trial eligibility requirements from the one or more clinical trial sponsors.

A clinical trial sponsor, such as a pharmaceutical company, the Food and Drug Administration (FDA), and the like, sends its clinical trial qualifications to a cloud-based application. A healthcare provider, such as a hospital, urgent care facility, pediatrician's office, and the like, receives the clinical trial qualifications. One or more EMRs of one or more patients of the healthcare provider are compared to the clinical trial qualifications. The clinical trial sponsors request a match of the one or more patients to the one or more clinical trials. It is determined if the patient is eligible to participate in one or more clinical trials based on the patient's EMR information and the participation qualifications of the one or more clinical trials. At step 314, the patient is notified of the results through the patient's mobile device or a secure website. Similarly, at step 316, those that have permission from the patient are notified of the results through their mobile device or a secure website.

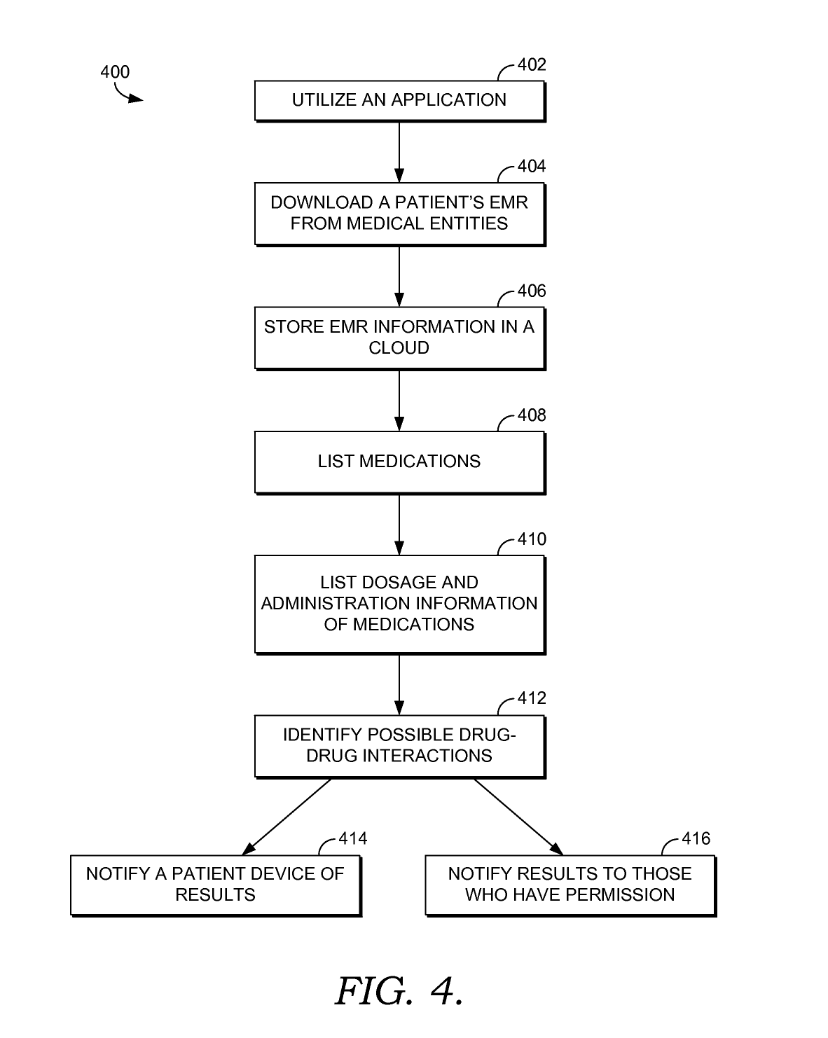

Turning now to FIG. 4, notifying a patient and/or those that have permission from the patient of possible drug-drug interactions from the one or more medications the patient is prescribed to take is illustrated as a block diagram 400. At step 402, an application is utilized to download a patient's EMR information from medical entities 404. At step 406, the patient's EMR information is stored in a cloud. Next, the EMR information for the patient that is stored in the cloud is accessed (not shown). At step 408, the one or more medications the patient is prescribed to take are listed. At step 410, the dosage and administration information of the one or more medications the patient is prescribed to take are listed. At step 412, possible drug-drug interactions of the medications the patient is prescribed to take are identified. Drug-drug interactions can mean that one medication or drug impedes the chemical activity and/or the absorption of another drug. As another example, a drug-drug interaction can mean that the two drugs are contraindicated and can cause an adverse drug event (ADE). An ADE is an atypical clinical event. At step 414, the patient is notified of the results through the patient's mobile device or a secure website. Similarly, at step 416, those that have permission from the patient are notified of the results through their mobile device or a secure website.

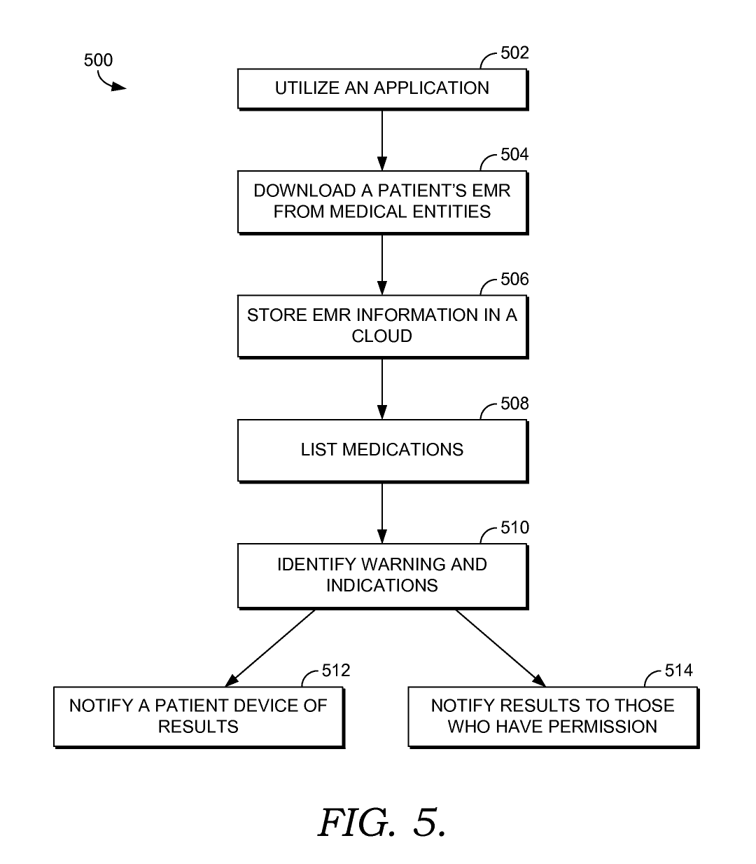

Turning now to FIG. 5, notifying a patient, those that have permission, and/or the patient's caregivers such as authorized physicians, physicians assistants, nurses and the like, from the patient that warnings and/or indications regarding the patient's medications have been identified is illustrated as a block diagram 500. At step 502, an application is utilized to download a patient's EMR information from medical entities 504. At step 506, the patient's EMR information is stored in a cloud. Next, the EMR information for the patient that is stored in the cloud is accessed (not shown). At step 508, the one or more medications the patient is prescribed to take are listed. At step 510, warnings and indications of the medications the patient is prescribed to take are identified. One example of a warning is a “black box” warning that can sometimes be found in the prescribing information or package insert of a medication. The “black box” warning is considered the strongest warning that the U.S. Food and Drug Administration (FDA) requires and signifies that the medication carries a significant risk of serious or even life-threatening adverse events. As new information regarding a medication may present itself only after the medication has been on the market, the FDA can require that a pharmaceutical company place a “black box” warning on the package insert after it has already been on the market. Similarly, the FDA can require a pharmaceutical company place a “black box” warning in literature describing the medication. Another type of warning includes contraindications, possible side-effects, warnings and precautions, and the like, that can be found in the prescribing information of the medication. Since a medication warning can present itself anytime during the life-time of the medication, the warning to the patient in the patient's EMR is in near real-time as to keep any warning up to date. That is, if the FDA approves a new warning about a medication that the patient is currently taking, this warning will be inserted into the patient's EMR as soon as the warning is issued (near real-time). Also at step 510, indications of the one or more medications the patient is prescribed to take are identified. Indications are also regulated by the FDA and are defined as the one or more diseases or medical conditions for which the medication is used. The indications for a drug can usually be found in the prescribing information or package insert under the phrase “Indications and Usage.” In one embodiment, indications can refer to the “label”, or FDA approved usage and/or it can refer to the “off-label”, or non FDA approved usage.

In one embodiment, the application further comprises a method of identifying possible drug-food interactions based on the one or more medications the patient is prescribed to take and the food the patient is eating while taking the one or more medications. In another embodiment, the application further comprises a method of identifying possible drug-gene interactions based on the one or more medications the patient is prescribed to take and genetic information of the patient. In another embodiment, the application comprises a method of identifying medications of the one or more medications the patient is prescribed to take that are covered by the patient's medical insurance. In yet another embodiment, the application further comprises a method of determining how much of the cost is covered by the patient's medical insurance of the one or more medications the patient is prescribed to take that are covered by the patient's medical insurance. In another embodiment, the application further comprises a method of determining generic options of the one or more medications the patient is prescribed to take. In yet another embodiment, the application comprises a method of determining the prescribing information for the one or more medications the patient is prescribed to take and the prescribing information for each of the one or more medications is maintained in near real-time. In another embodiment, the application further comprises a method of identifying medication allergies to the one or more medications the patient is prescribed to take.

What is claimed is:

1. A method in a medical information computing environment for notifying a patient of clinical trial eligibility, the method comprising:
utilizing an application for the following:
downloading EMR information for a patient from one or more medical entities;
storing the downloaded EMR information for the patient in a cloud;
accessing the EMR information for the patient in the cloud;
determining if there are one or more clinical trials near the patient;
if there are the one or more clinical trials near the patient, automatically comparing the patient's EMR information to the one or more clinical trial participation qualifications;
determining if the patient is eligible to participate in the one or more clinical trials;
notifying a patient device of results; and
notifying the results to one or more devices that belong to people that the patient has given permission to receive the results.

2. The method of claim 1, wherein the cloud is a personal cloud.

3. A method in a medical information computing environment for notifying a patient of drug-drug interactions, the method comprising:
utilizing an application for the following:
downloading EMR information for a patient from one or more medical entities;
storing the downloaded EMR information for the patient in a cloud;
accessing the EMR information for the patient in the cloud;
listing one or more medications the patient is prescribed to take;
listing a dosage and administration information of the one or more medications the patient is prescribed to take;
identifying one or more possible drug-drug interactions based on a list of two or more medications the patient is prescribed to take;
if there is the one or more drug-drug interactions, notifying a patient device of results; and
notifying the results to one or more devices that belong to people that the patient has given permission to receive the results.

4. The method of claim 3, wherein the cloud is a personal cloud.

5. The method of claim 3, wherein the application further comprises a method of identifying possible drug-food interactions based on the one or more medications the patient is prescribed.

6. The method of claim 3, wherein the application further comprises a method of identifying possible impact of the patient's genetic characteristics to the one or more medications the patient is prescribed.

7. The method of claim 3, wherein the application further comprises a method of identifying possible side-effects of the one or more medications the patient is prescribed to take.

8. The method of claim 3, wherein the application further comprises a method of identifying medications of the one or more medications the patient is prescribed to take that are covered by the patient's medical insurance.

9. The method of claim 8, wherein the application further comprises a method of determining how much cost is covered by the patient's medical insurance of the one or more medications the patient is prescribed to take that are covered by the patient's medical insurance.

10. The method of claim 8, wherein the application further comprises a method of determining generic options of the one or more medications the patient is prescribed to take.

11. The method of claim 3, wherein the application further comprises a method of determining the prescribing information for the one or more medications the patient is prescribed to take.

12. The method of claim 11, wherein the prescribing information for each of the one or more medications the patient is currently taking is maintained in near real-time.

13. The method of claim 3, wherein the application further comprises a method of identifying medication allergies to the one or more medications the patient is prescribed to take.

14. A method in a medical information computing environment for identifying any warnings and indications regarding the one or more medications the patient is prescribed to take, the method comprising:
utilizing an application for the following:
downloading EMR information for a patient from one or more medical entities;
storing the downloaded EMR information for the patient in a cloud;
accessing the EMR information for the patient in the cloud;
listing one or more medications the patient is prescribed to take;
identifying any warnings and indications regarding the one or more medications the patient is prescribed to take;
notifying a patient device of results; and
notifying the results to one or more devices that belong to people that the patient has given permission to receive the results.

15. The method of claim 14, wherein the application further comprises a method of identifying possible side-effects of the one or more medications the patient is prescribed to take.

16. The method of claim 14, wherein the application further comprises a method of determining the prescribing information for the one or more medications the patient is prescribed to take.

17. The method of claim 16, wherein the prescribing information for each of the one or more medications the patient is currently taking is maintained in near real-time.

18. The method of claim 14, wherein the application further comprises a method of identifying medication allergies to the one or more medications the patient is prescribed to take.

19. The method of claim 14, wherein the application further comprises a method of identifying possible drug-food interactions based on the one or more medications the patient is prescribed to take and food the patient is eating while taking the one or more medications.

20. The method of claim 14, wherein the application further comprises a method of identifying possible drug-gene interactions based on the one or more medications the patient is prescribed to take and genetic information of the patient.
